(19) United States
(12) Patent Application Publication
(10) Pub. No.: US 2023/0052331 A1
(43) Pub. Date: Feb. 16, 2023

(54) EXPANDABLE PLANT CADDY

(71) Applicant: The Ames Companies, Inc., Camp Hill, PA (US)

(72) Inventors: Chun Wai HUNG, Dillsburg, PA (US); Amy BRINCKERHOFF, Marietta, GA (US); John JOYCE, Lilburn, GA (US); Ryan Barclay BISHOP, Ocala, FL (US)

(21) Appl. No.: 17/402,962

(22) Filed: Aug. 16, 2021

(51) Int. Cl. A47G 7/04; F16M 11/42

(52) U.S. Cl. CPC A47G 7/041; F16M 11/42

(57) ABSTRACT

An expandable plant caddy assembly is provided with a frame with a plurality of legs. A plurality of plates is each mounted for translation to one of the plurality of legs, to collectively support a planter, and to allow expansion to accommodate planters of varying sizes. A plurality of guides is each mounted to one of the plurality of plates to connect each plate for translation along the corresponding leg of the plurality of legs. A plurality of casters is each mounted to one of the plurality of guides with the corresponding leg therebetween to apply compression upon the corresponding leg between the caster and the guide to resist inadvertent adjustment of each of the plurality of plates, and to permit travel of the expandable plant caddy.

### TECHNICAL FIELD

Various embodiments relate to expandable plant caddies.

### BACKGROUND

The prior art has provided plant caddies for supporting and transporting a planter.

### SUMMARY

According to an embodiment, an expandable plant caddy is provided with a frame with a plurality of radially outward extending legs to contact an underlying support surface. A plurality of plates is each mounted for translation to one of the plurality of legs, to collectively receive and support a planter upon the frame, and to expand and retract to adjust an overall size of the plurality of plates.

According to a further embodiment, a plurality of guides is each mounted to one of the plurality of plates to connect each plate for translation along one of the plurality of legs.

According to an even further embodiment, a plurality of slots, is each formed through one of the plurality of legs or the plurality of guides. A plurality of fasteners is installed in the slots to limit a range of translation of each of the plurality of plates relative to the corresponding leg.

According to another further embodiment, a center plate is mounted to the frame and oriented centrally relative to the plurality of plates.

According to an even further embodiment, the center plate and the plurality of translatable plates collectively receive and support the planter.

According to another even further embodiment, the center plate and the plurality of translatable plates are each provided with a contact surface to receive the planter. The contact surfaces of the center plate and the plurality of translatable plates are generally flush with each other.

According to another even further embodiment, a recess is formed within a perimeter of each of the plurality of translatable plates, and is sized to engage a portion of a perimeter of the center plate.

According to another further embodiment, each of the plurality of plates is further provided with a projection extending from an outward peripheral edge to retain the planter thereupon.

According to another further embodiment, the expandable plant caddy is sized to receive and support a planter base with a diameter of twelve inches in a retracted position.

According to another further embodiment, the expandable plant caddy is sized to receive and support a planter base with a diameter of sixteen inches in an expanded position.

According to another further embodiment, the plurality of plates is further provided with at least three plates.

According to another further embodiment, a plurality of casters is each mounted to one of the plurality of plates for transportation of the expandable plant caddy upon the underlying support surface.

According to an even further embodiment, each of the plurality of casters are mounted to the corresponding plate of the plurality of plates with the corresponding leg of the plurality of legs therebetween to apply compression upon the corresponding leg to resist inadvertent adjustment of each of the plurality of plates.

According to another even further embodiment, a plurality of guides is each mounted to one of the plurality of plates to connect each plate for translation along one of the plurality of legs. The corresponding caster of the plurality of casters is mounted to the corresponding guide of the plurality of guides.

According to another even further embodiment, a plurality of fasteners connects the plurality of casters to the plurality of guides.

According to another even further embodiment, each of the plurality of fasteners is installed under tension.

According to another embodiment, an expandable plant caddy is provided with a frame with a plurality of legs. A plurality of plates is each mounted for translation to one of the plurality of legs, to collectively support a planter, and to expand and retract to adjust an overall size of the plurality of plates. A plurality of casters is each mounted to one of the plurality of plates with the corresponding leg therebetween to apply compression upon the corresponding leg to resist inadvertent adjustment of each of the plurality of plates, and to permit travel of the expandable plant caddy upon an underlying support surface.

According to a further embodiment, the plurality of casters is provided with at least three casters.

According to an even further embodiment, a plurality of fasteners connects the plurality of casters to the plurality of plates.

According to another even further embodiment, each of the plurality of fasteners is installed under tension.

According to another embodiment, an expandable plant caddy assembly is provided with a frame with a plurality of legs. A plurality of plates is each mounted for translation to one of the plurality of legs, to collectively support a planter, and to allow expansion to accommodate planters of varying sizes. A plurality of guides is each mounted to one of the plurality of plates to connect each plate for translation along the corresponding leg of the plurality of legs. A plurality of casters is each mounted to one of the plurality of guides with the corresponding leg therebetween to apply compression upon the corresponding leg between the caster and the guide to resist inadvertent adjustment of each of the plurality of plates, and to permit travel of the expandable plant caddy.

### BRIEF DESCRIPTION OF THE DRAWINGS

FIG. 1 is a top, side perspective view of an expandable plant caddy assembly according to an embodiment, illustrated in a retracted condition;

FIG. 2 is a top plan view of the expandable plant caddy assembly of FIG. 1, illustrated in the retracted condition;

FIG. 3 is a side elevation view of the expandable plant caddy assembly of FIG. 1, illustrated in the retracted condition;

FIG. 4 is a bottom perspective view of the expandable plant caddy assembly of FIG. 1, illustrated in the retracted condition;

FIG. 5 is a bottom view of the expandable plant caddy assembly of FIG. 1, illustrated in the retracted condition;

FIG. 6 is a top, side perspective view of the expandable plant caddy assembly of FIG. 1, illustrated in an expanded condition;

FIG. 7 is a top plan view of the expandable plant caddy assembly of FIG. 1, illustrated in the expanded condition;

FIG. 8 is a side elevation view of the expandable plant caddy assembly of FIG. 1, illustrated in the expanded condition;

FIG. 9 is a bottom perspective view of the expandable plant caddy assembly of FIG. 1, illustrated in the expanded condition;

FIG. 10 is a bottom view of the expandable plant caddy assembly of FIG. 1, illustrated in the expanded condition;

FIG. 11 is a top, side perspective view of an expandable plant caddy assembly according to another embodiment, illustrated in a retracted condition;

FIG. 12 is a top plan view of the expandable plant caddy assembly of FIG. 11, illustrated in the retracted condition;

FIG. 13 is a side elevation view of the expandable plant caddy assembly of FIG. 11, illustrated in the retracted condition;

FIG. 14 is a bottom perspective view of the expandable plant caddy assembly of FIG. 11, illustrated in the retracted condition;

FIG. 15 is a bottom view of the expandable plant caddy assembly of FIG. 11, illustrated in the retracted condition;

FIG. 16 is a top, side perspective view of the expandable plant caddy assembly of FIG. 11, illustrated in an expanded condition;

FIG. 17 is a top plan view of the expandable plant caddy assembly of FIG. 11, illustrated in the expanded condition;

FIG. 18 is a side elevation view of the expandable plant caddy assembly of FIG. 11, illustrated in the expanded condition;

FIG. 19 is a bottom perspective view of the expandable plant caddy assembly of FIG. 11, illustrated in the expanded condition;

FIG. 20 is a bottom view of the expandable plant caddy assembly of FIG. 11, illustrated in the expanded condition;

FIG. 21 is a side perspective, partial section view of the expandable plant caddy assembly of FIG. 11, illustrated in the retracted condition;

FIG. 22 is a side perspective, partial section view of the expandable plant caddy assembly of FIG. 11, illustrated in the expanded condition;

FIG. 23 is a side perspective view of a fastener of the plant caddy assembly of FIG. 11, according to another embodiment;

FIG. 24 is a bottom end view of the fastener of FIG. 23;

FIG. 25 is a side elevation view of the fastener of FIG. 23;

FIG. 26 is a top plan view of an expandable plant caddy assembly according to another embodiment, illustrated in the expanded condition; and

FIG. 27 is a side elevation view of the expandable plant caddy assembly of FIG. 26, illustrated in the expanded condition.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

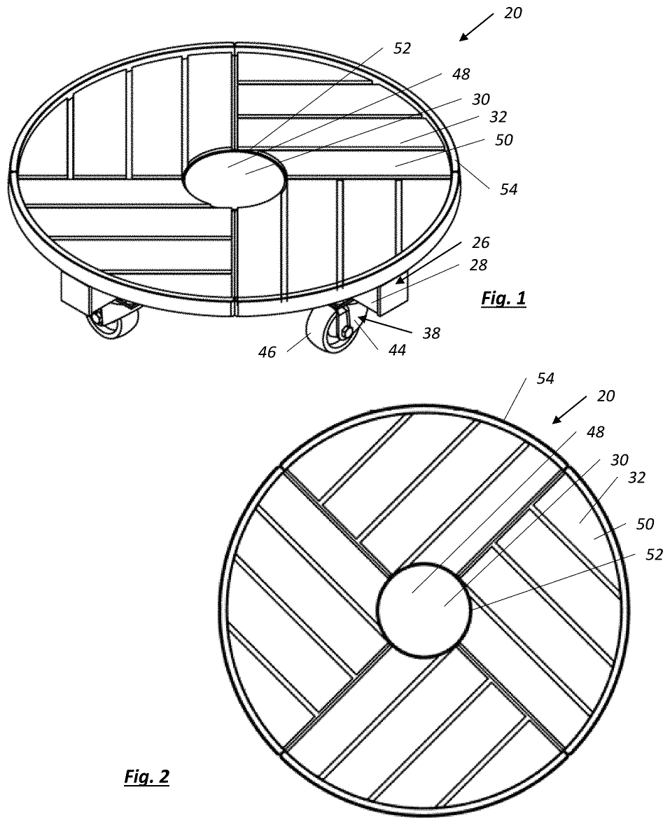

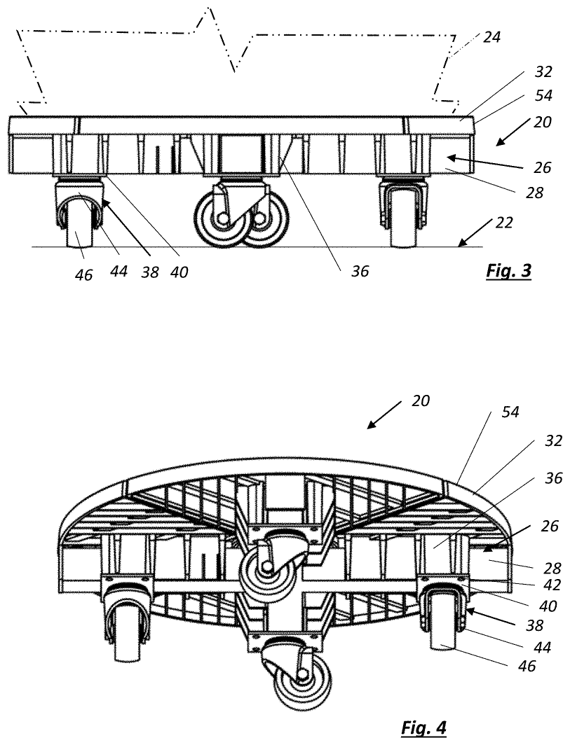

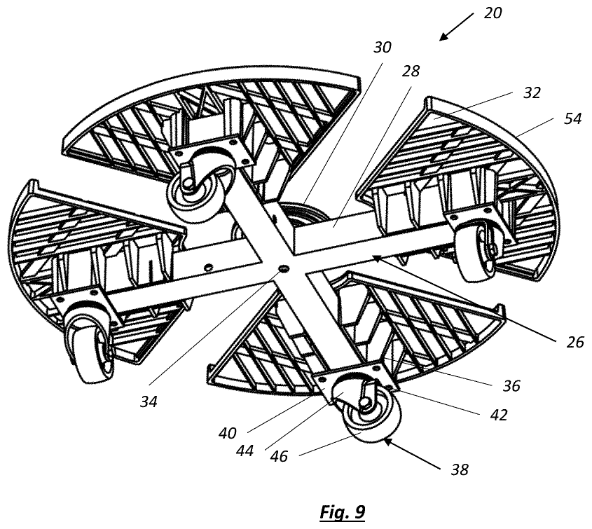

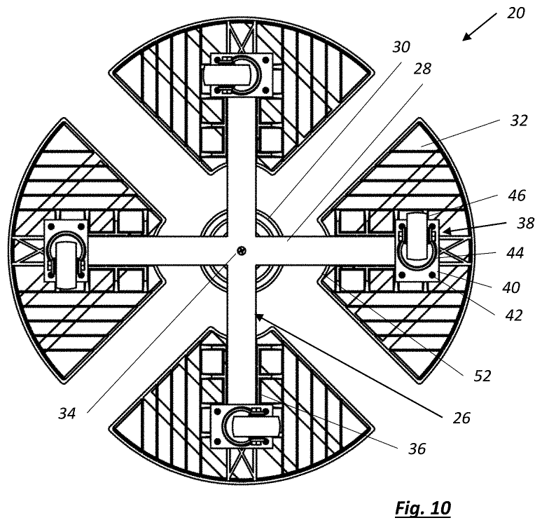

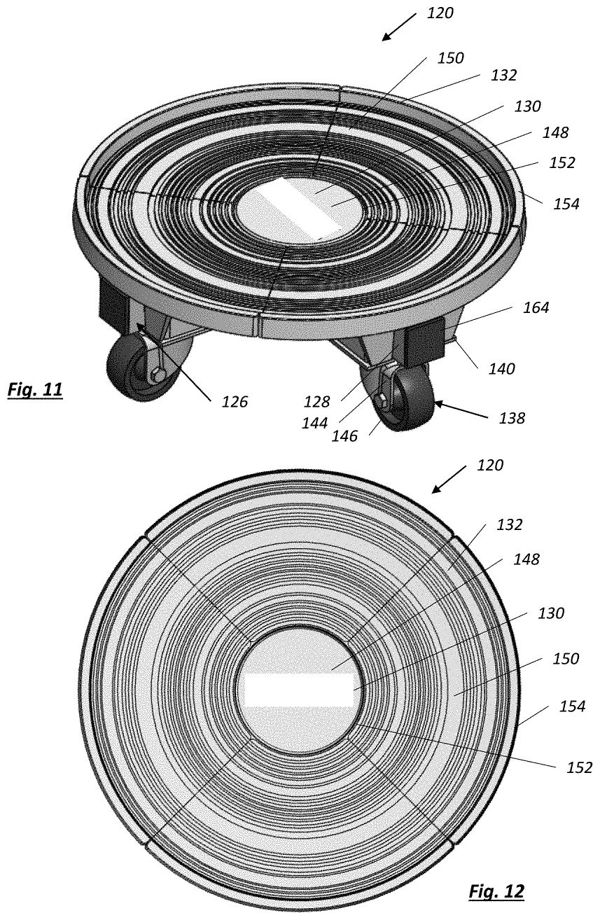

FIGS. 1-10 illustrate an expandable plant caddy assembly 20 according to an embodiment. The expandable plant caddy assembly 20 is utilized for resting and transportation upon an underlying support surface 22, such as a floor or patio. The expandable plant caddy assembly 20 is utilized to receive and support a potted planter 24 at an elevation above the floor 22. The potted planter 24 is illustrated partially and in phantom in FIG. 3. The plant caddy assembly 20 elevates the potted planter 24 for visual aesthetics to raise the potted planter 24. The plant caddy assembly 20 may also be employed to raise a plant away from the ground 22 for plants with leaves, branches or vines that may extend below a depth of the potted planter 24.

The plant caddy assembly 20 is also transportable to assist in movement for decorating, and redecorating an associated environment, such as a deck, patio, garden, room, or the like. Potted planters 24 with rocks, soil, plants and/or the like can be relatively heavy and difficult to transport without a caddy.

The plant caddy assembly 20 is expandable for receiving and supporting potted planters 24 of various diameters. For example, the potted planter 24 in FIG. 3 may have a base diameter of twelve inches or less, according to an embodiment.

The plant caddy assembly 20 is generally round, akin to a base of most planters 24. However, any shape or configuration may be employed. The plant caddy assembly 20 includes a frame 26. The frame 26 includes a plurality, such as four, radially outward extending legs 28. Although four legs 28 are illustrated and described, three or more legs 28 may be utilized. The frame 26 may be formed from a structural material, such as a polymeric material, or a metallic material. The frame 26 may be molded, cast, stamped, welded or the like. The legs 28 may be employed to support the plant caddy assembly 20 upon the floor 22, while supporting the planter 24.

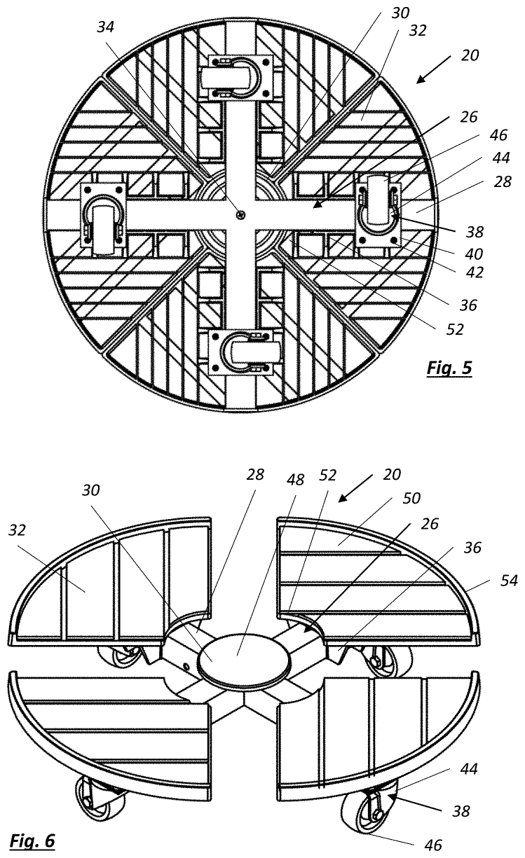

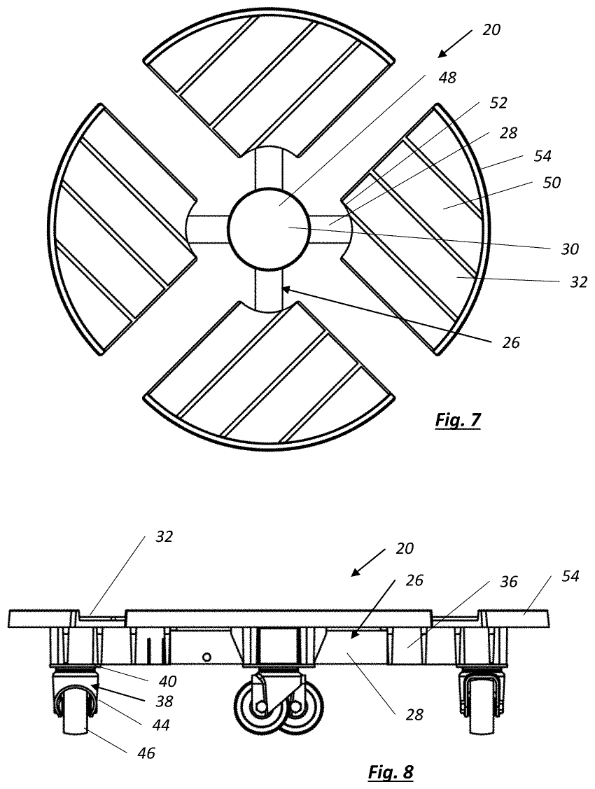

A plurality of plates 30, 32 are mounted to the frame 26 to receive and support the planter 24 upon the frame 26. One of the plates 30, is a center hub plate 30 that is stationary relative to the frame 26 and mounted at an intersection of the legs 28. According to an embodiment, the center plate 30 is round. The center plate 30 may be formed from a molded polymeric material. The center plate 30 may be attached to the frame 26 by a fastener 34 as illustrated in FIGS. 5, 9 and 10.

The other plates 32 are arranged as quadrants about the center plate 30. Each of the quadrant plates 32 is mounted to one of the legs 28 to translate along the corresponding leg 28. The plates 32 are each formed integrally with a guide 36 that is sized to receive one of the legs 28. Each plate 32 and associated guide 36 may be formed from a molded polymeric material. The plate 32 rests upon the leg 28; and the guide 36 constrains lateral sides of the leg 28.

The plant caddy assembly 20 includes a plurality of casters 38 to support the plant caddy assembly 20 upon the underlying support surface 22. The casters 38 also permit transportation of the plant caddy assembly 20 along the underlying support surface 22. The casters 38 each include a mounting plate 40 that is fastened to the guide 36 of one of the quadrant plates 32 by a plurality of fasteners 42, such as screws, rivets, or the like. Each caster 38 also includes a bracket 44, which is rotationally connected to the mounting plate 40 about an upright axis for directional rotation of the bracket 44 relative to mounting plate 40. A wheel 46 is connected to each bracket 44 for rotation about a horizontal axis.

The mounting plate 40 of each caster 38 constrains a lower side of each leg 28 so that the plate 32 with the guide 36 and the caster 38 can translate along the leg 28. This adjustability of the quadrant plates 32 permits expansion and retraction of the plates 32 for planters of varying sizes. The plant caddy assembly 20 is illustrated in a retracted position in FIGS. 1-5, and in an expanded position in FIGS. 6-10.

Each of the support plates 30, 32 has an upper contact surface 48, 50 to collectively receive and support the planter 24. The contact surfaces 48, 50 may be provided relatively flush to each other, to provide collective support in the retracted and the expanded positions. The quadrant plates 32 are illustrated with one example of a decorative surface ornamentation upon the contact surfaces 50. Other decorative surfaces may be employed, such as wicker, wood, or the like. The quadrant plates 32 converge upon the center plate 30 in the retracted position. Each of the quadrant plates 32 include an arcuate recess 52 at an inner perimeter to engage an outer perimeter of the center plate 30 in the retracted position. A ridge 54 projects upward from an outer perimeter of each of the quadrant plates 32 to retain the planter 24 upon the plates 32.

The fasteners 42 are installed in tension to apply compression on each leg 28 between one of the quadrant plates 32 and the mounting plate 40 of the caster 38. The compression upon the leg 28 resists inadvertent adjustment of the plurality of plates 32 to maintain an adjusted of the plant caddy assembly 20. The expandable plant caddy assembly 20 is adjustable for supporting potted planters with a base up to twelve inches in diameter in the retracted position, for example. The expandable plant caddy assembly 20 is sized to support potted planters with a base diameter up to sixteen inches in the expanded position according to another example. Various dimensional ranges may be obtained by sizing the frame 26 and the plates 30, 32 according to various embodiments.

According to at least one embodiment, an overall ornamental appearance of the expandable plant caddy assembly 20 is illustrated in FIGS. 1-5. According to at least another embodiment, an overall ornamental appearance of the expandable plant caddy assembly 20 is illustrated in FIGS. 6-10. According to at least other embodiments, an overall ornamental appearance of the expandable plant caddy assembly 20 may be provided without fasteners 34, 42, surface ornamentation, or casters 38.

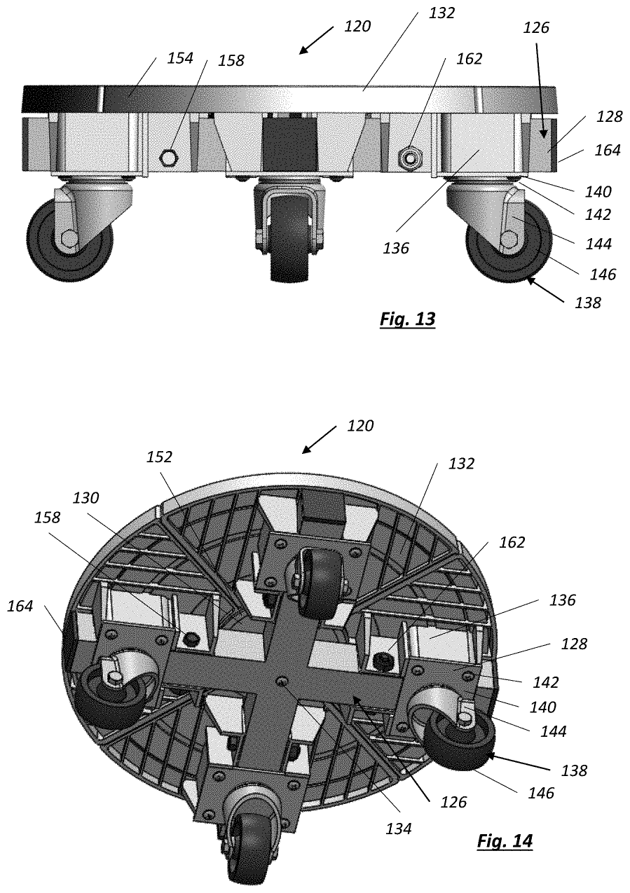

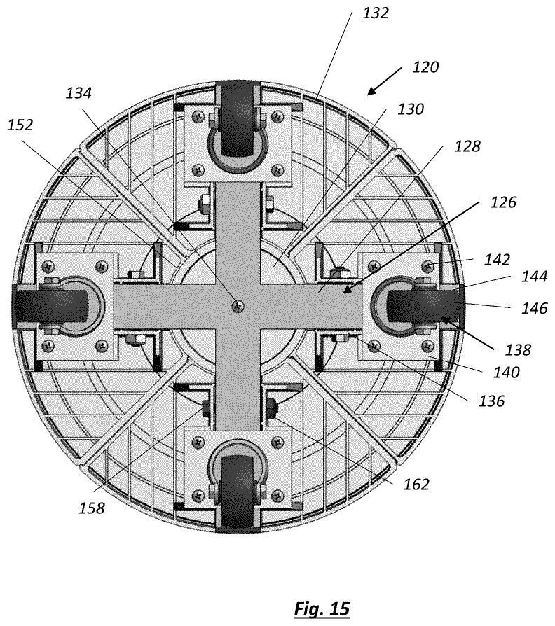

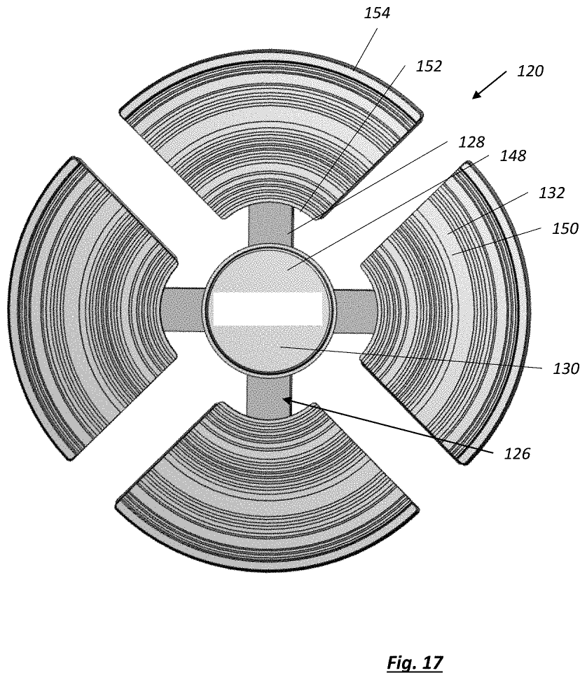

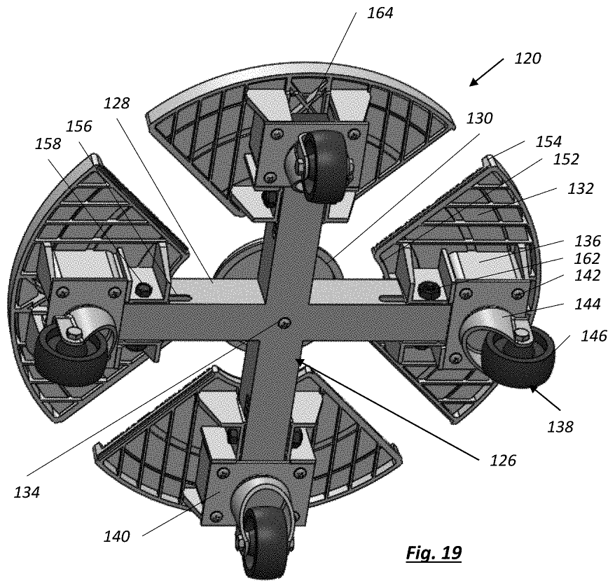

FIGS. 11-22 illustrate an expandable plant caddy assembly 120 according to another embodiment. The expandable plant caddy assembly 120 is utilized for resting and transportation upon the floor 22. The expandable plant caddy assembly 120 is utilized to receive and support the potted planter 24 at an elevation above the floor 22. The plant caddy assembly 120 is also transportable. The plant caddy assembly 120 is expandable for receiving and supporting potted planters 24 of various diameters.

The plant caddy assembly 120 is generally round, akin to a base of most planters 24. However, any shape or configuration may be employed. The plant caddy assembly 120 includes a frame 126. The frame 126 includes a plurality, such as four, radially outward extending legs 128. The frame 126 may be formed from a structural material, such as a polymeric material, or a metallic material. The frame 126 may be molded, cast, stamped, welded or the like. The legs 128 may be employed to support the plant caddy assembly 120 upon the floor 22, while supporting the planter 24.

A plurality of plates 130, 132 are mounted to the frame 126 to receive and support the planter 24 upon the frame 126. One of the plates 130, is a center hub plate 130 that is stationary relative to the frame 126 and mounted at an intersection of the legs 128. According to an embodiment, the center plate 130 is round. The center plate 130 may be formed from a molded polymeric material. The center plate 130 may be attached to the frame 126 by a fastener 134 as illustrated in FIGS. 14, 15, 19 and 20.

The outer plates 132 are arranged as quadrants about the center plate 130. Each of the quadrant plates 132 is mounted to one of the legs 128 to translate along the corresponding leg 128. The plates 132 are each formed integrally with a guide 136 that is sized to receive one of the legs 128. Each plate 132 and associated guide 136 may be formed from a molded polymeric material. The plate 132 rests upon the leg 128; and the guide 136 constrains lateral sides of the leg 128.

The plant caddy assembly 120 includes a plurality of casters 138 to support the plant caddy assembly 120 upon the underlying support surface 22. The casters 138 also permit transportation of the plant caddy assembly 120 along the underlying support surface 22. The casters 138 each include a mounting plate 140 that is fastened to the guide 136 of one of the quadrant plates 132 by a plurality of fasteners 142, such as screws, rivets, or the like. Each caster 138 also includes a bracket 144, which is rotationally connected to the mounting plate 140 about an upright axis for directional rotation of the bracket 144 relative to mounting plate 140. A wheel 146 is connected to each bracket 144 for rotation about a horizontal axis.

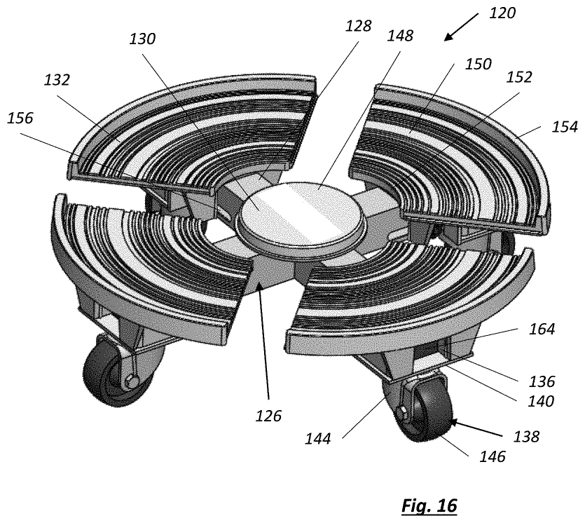

The mounting plate 140 of each caster 138 constrains a lower side of each leg 128 so that the quadrant plate 132 with the guide 136 and the caster 138 can translate along the leg 128. This adjustability of the quadrant plates 132 permits expansion and retraction of the plates 132 for planters of varying sizes. The plant caddy assembly 120 is illustrated in a retracted position in FIGS. 11-15, and in an expanded position in FIGS. 16-20.

Each of the support plates 130, 132 has an upper contact surface 148, 150 to collectively receive and support the planter 24. The contact surfaces 148, 150 may be provided relatively flush to each other, to provide collective support in the retracted and the expanded positions. The quadrant plates 132 converge upon the center plate 130 in the retracted position. Each of the quadrant plates 132 include an arcuate recess 152 at an inner perimeter to engage an outer perimeter of the center plate 130 in the retracted position. A ridge 154 projects upward from an outer perimeter of each of the quadrant plates 132 to retain the planter 24 upon the plates 132.

The fasteners 142 are installed in tension to apply compression on each leg 128 between one of the quadrant plates 132 and the mounting plate 140 of the caster 138. The compression upon the leg 128 resists inadvertent adjustment of the plurality of plates 132 to maintain an adjusted of the plant caddy assembly 120. The expandable plant caddy assembly 120 is adjustable for supporting potted planters 24 with a base up to twelve inches in diameter in the retracted position, for example. The expandable plant caddy assembly 120 is sized to support potted planters 24 with a base diameter up to sixteen inches in the expanded position according to another example. Various dimensional ranges may be obtained by sizing the frame 126 and the plates 130, 132 according to various embodiments.

According to at least one embodiment, an overall ornamental appearance of the expandable plant caddy assembly 120 is illustrated in FIGS. 11-15. According to at least another embodiment, an overall ornamental appearance of the expandable plant caddy assembly 120 is illustrated in FIGS. 16-20. According to at least other embodiments, an overall ornamental appearance of the expandable plant caddy assembly 120 may be provided without fasteners 134, 142, surface ornamentation, or casters 138.

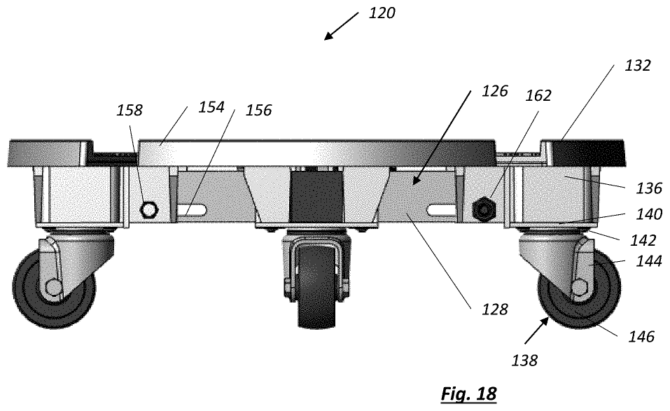

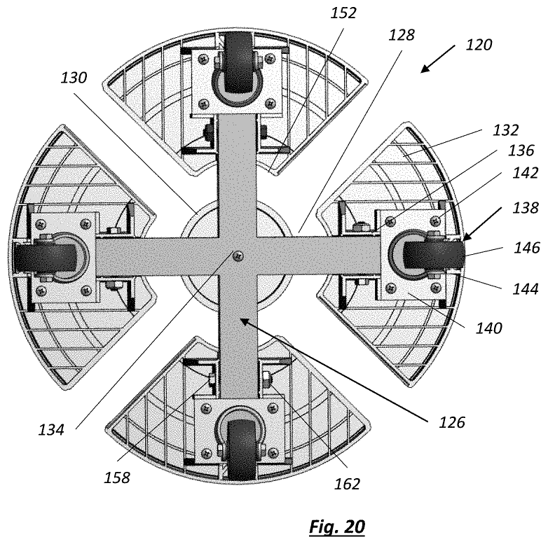

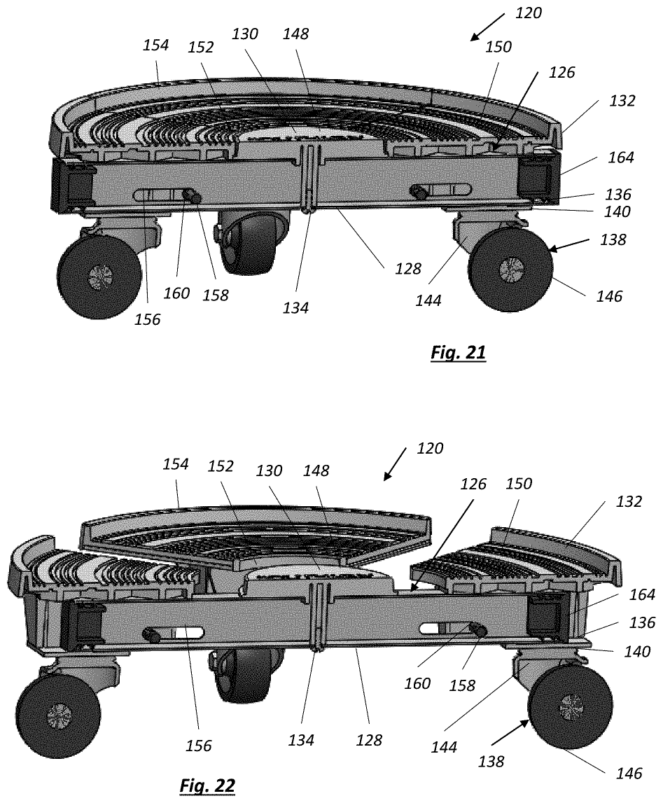

The casters 138 are oriented generally outboard in order to enhance stability and performance of the plant caddy 120. In order to limit a range of translation of the quadrant plates 132 relative to the frame 126, a retention feature is provided in the frame 126 and the guides 136. Referring to FIGS. 18, 19, 21 and 22 the retention feature includes a plurality of slots 156 are formed through each of the legs 128 of the frame 126. A plurality of fasteners, such as bolts 158 extend through an aperture 160 (FIGS. 21 and 22) in the guides 136 and through the slots 156 of the frame 126. A plurality of nuts 162 (FIGS. 18-20) may be installed upon the free distal ends of the bolts 158 to secure the bolts 158 in the slots 156 and apertures 160. Although the slots 156 are provided in the frame 126, the slots 156 could be provided in the guide 136 according to another embodiment. The slots 156 provide a limit to a range of translation of the quadrant plates 132 to avoid overtravel or inadvertent disassembly of the planter caddy 120.

With continued reference to FIGS. 21 and 22, a polymeric cap 164 is installed into an open hollow end of each leg 128 of the frame 126. The cap 164 provides a decorative appearance of an enclosed design.

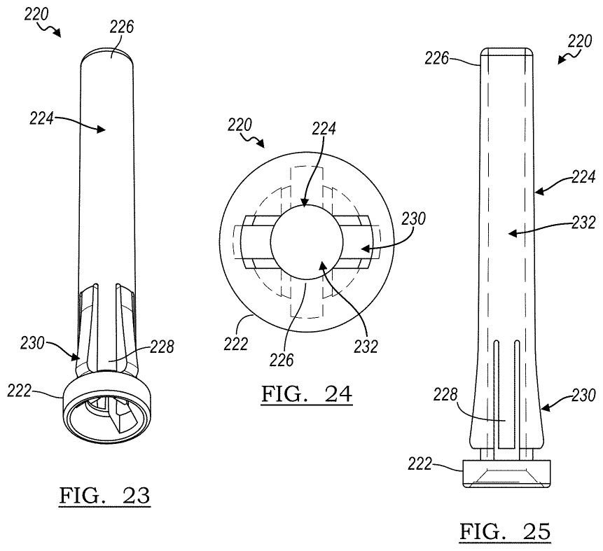

Although bolts 158 and nuts 162 are illustrated and described, other fasteners may be employed, such as rivets. Referring now to FIGS. 23-25 an alternate fastener is illustrated as an anchor 220 with reverse locking capability. The anchor 220 can be installed through the apertures and the slot 156. Then a screw or bolt 158 is installed into the anchor 220 to lock the anchor 220 in the apertures 160 and the slot 156.

The anchor 220 may be constructed from a polymeric material, such as an acetal copolymer, or any other suitable material. The back anchor 220 may include a head portion 222 and a shaft portion 224 extending therefrom. As shown, the head portion 222 may have a larger diameter than the shaft portion 224 and is sized to receive the head of the threaded fastener 158 thereon or therein when installed.

The shaft portion 224 has a diameter sized to be received through the apertures 160 of the guides 136 and the slots 156 of the frame 126. The shaft portion 224 may be tapered toward a distal end 226 thereof in order to facilitate insertion of the shaft portion 224 into the apertures 160 and slots 156. The distal end 226 may also be rounded to facilitate initial insertion. A proximal end 228 of the shaft portion 224 may include a plurality of flexible, resilient arms 230 that protrude outwardly from the shaft portion 224 in a resting position. When the shaft portion 224 is inserted into the apertures 160 and the slots 158, the flexible arms 230 are compressed inward as they pass through the first aperture 160 and the first slot 158, and then expand outwardly to engage an interior of the hollow leg 128 of the frame 126 and provide resistance to dislodging the anchor 220 from the support plate 132 and the frame 126.

The shaft portion 224 is hollow, defining a channel 232 therethrough sized to receive the screw 158, wherein a length of the channel 232 is shorter than a length of the screw shank. With the anchor 220 installed, the screw 158 may be inserted into the channel 232 of the anchor 220 where the shank will engage an interior of the flexible arms 230, causing the arms 230 to deflect outwardly beyond their resting position. Due to the resilient bias of the arms 230, which return toward the resting position, the arms 230 hold the screw shank when the screw 158 is at least partially inserted into the anchor 220.

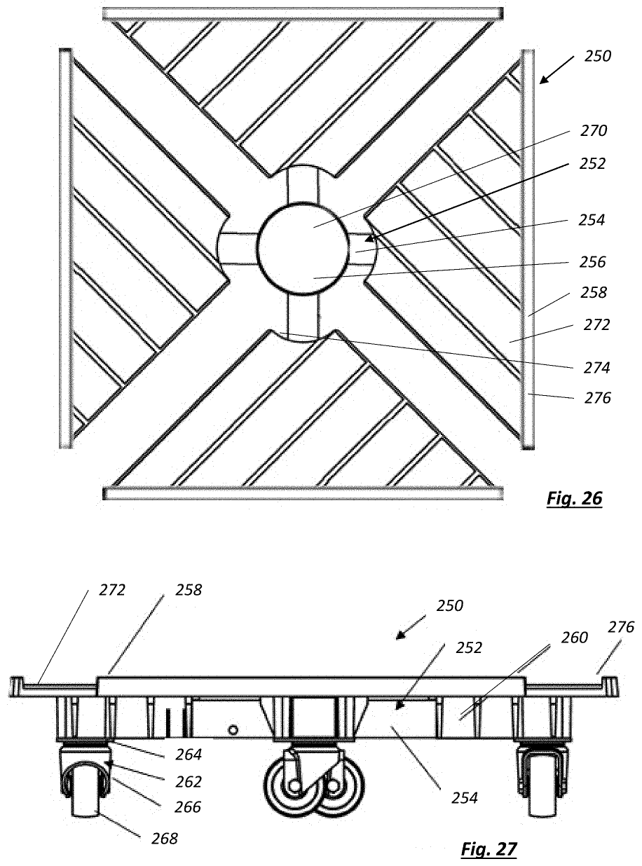

FIGS. 26 and 27 illustrate an expandable plant caddy assembly 250 according to another embodiment. The expandable plant caddy assembly 250 is utilized for resting and transportation upon the underlying support surface 22. The expandable plant caddy assembly 250 is utilized to receive and support a potted planter 24 at an elevation above the floor 22. The plant caddy assembly 250 elevates the potted planter 24 for visual aesthetics to raise the potted planter 24. The plant caddy assembly 250 may also be employed to raise a plant away from the ground 22 for plants with leaves, branches or vines that may extend below a depth of the potted planter 24.

The plant caddy assembly 250 is also transportable to assist in movement for decorating, and redecorating an associated environment, such as a deck, patio, garden, room, or the like. Potted planters 24 with rocks, soil, plants and/or the like can be relatively heavy and difficult to transport without a caddy. The plant caddy assembly 250 is expandable for receiving and supporting potted planters 24 of various diameters.

The plant caddy assembly 250 is generally rectangular. For the depicted embodiment, the plant caddy assembly 250 has an overall floor plan that is in the shape of a square, akin to a base of rectangular planters. However, any shape or configuration may be employed. The plant caddy assembly 250 includes a frame 252. The frame 252 includes four radially outward extending legs 254.

A plurality of plates 256, 258 are mounted to the frame 252 to receive and support the planter 24 upon the frame 252. One of the plates 256, is a center hub plate 256 that is stationary relative to the frame 252 and mounted at an intersection of the legs 254. According to an embodiment, the center plate 256 is round. The center plate 256 may be formed from a molded polymeric material. The center plate 256 may be attached to the frame 252 by a fastener as illustrated in prior embodiments.

The other plates 258 are arranged as quadrants about the center plate 256. Each of the quadrant plates 258 is mounted to one of the legs 254 to translate along the corresponding leg 254. The plates 258 are each formed integrally with a guide 260 that is sized to receive one of the legs 254. Each plate 258 and associated guide 260 may be formed from a molded polymeric material. The plate 258 rests upon the leg 254; and the guide 260 constrains lateral sides of the leg 254.

The plant caddy assembly 250 includes a plurality of casters 262 to support the plant caddy assembly 250 upon the underlying support surface 22. The casters 262 also permit transportation of the plant caddy assembly 250 along the underlying support surface 22. The casters 262 each include a mounting plate 264 that is fastened to the guide 260 of one of the quadrant plates 258 by a plurality of fasteners. Each caster 262 also includes a bracket 266, which is rotationally connected to the mounting plate 264 about an upright axis for directional rotation of the bracket 266 relative to mounting plate 264. A wheel 268 is connected to each bracket 266 for rotation about a horizontal axis.

The mounting plate 264 of each caster 262 constrains a lower side of each leg 254 so that the plate 258 with the guide 260 and the caster 262 can translate along the leg 254. This adjustability of the quadrant plates 258 permits expansion and retraction of the plates 258 for planters of varying sizes. The plant caddy assembly 250 is illustrated in an expanded position in FIGS. 26 and 27.

Each of the support plates 256, 258 has an upper contact surface 270, 272 to collectively receive and support the planter 24. The contact surfaces 270, 272 may be provided relatively flush to each other, to provide collective support in the retracted and the expanded positions. The quadrant plates 258 are illustrated with one example of a decorative surface ornamentation upon the contact surfaces 272. Other decorative surfaces may be employed, such as wicker, wood, or the like. The quadrant plates 258 converge upon the center plate 256 in the retracted position. Each of the quadrant plates 258 include an arcuate recess 274 at an inner perimeter to engage an outer perimeter of the center plate 256 in the retracted position. A ridge 276 projects upward from an outer perimeter of each of the quadrant plates 258 to retain the planter 24 upon the plates 258. Various dimensional ranges may be obtained by sizing the frame 252 and the plates 256, 258 according to various embodiments.

According to at least one embodiment, an overall ornamental appearance of the expandable plant caddy assembly 250 is illustrated in FIGS. 26 and 27. According to at least other embodiments, an overall ornamental appearance of the expandable plant caddy assembly 250 may be provided without fasteners, surface ornamentation, or casters 262.

While various embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. An expandable plant caddy comprising:
a frame with a plurality of radially outward extending legs to contact an underlying support surface; and
a plurality of plates each mounted for translation to one of the plurality of legs, to collectively receive and support a planter upon the frame, and to expand and retract to adjust an overall size of the plurality of plates.

2. The expandable plant caddy of claim 1, further comprising a plurality of guides, each mounted to one of the plurality of plates to connect each plate for translation along one of the plurality of legs.

3. The expandable plant caddy of claim 2 wherein a plurality of slots, is each formed through one of the plurality of legs or the plurality of guides; and
wherein the expandable plant caddy further comprises a plurality of fasteners installed in the slots to limit a range of translation of each of the plurality of plates relative to the corresponding leg.

4. The expandable plant caddy of claim 1, further comprising a center plate mounted to the frame and oriented centrally relative to the plurality of plates.

5. The expandable plant caddy of claim 4 wherein the center plate and the plurality of translatable plates collectively receive and support the planter.

6. The expandable plant caddy of claim 4 wherein the center plate and the plurality of translatable plates are each provided with a contact surface to receive the planter; and
wherein the contact surfaces of the center plate and the plurality of translatable plates are generally flush with each other.

7. The expandable plant caddy of claim 6 wherein a recess is formed within a perimeter of each of the plurality of translatable plates, and is sized to engage a portion of a perimeter of the center plate.

8. The expandable plant caddy of claim 1, wherein each of the plurality of plates further comprises a projection extending from an outward peripheral edge to retain the planter thereupon.

9. The expandable plant caddy of claim 1, wherein the expandable plant caddy is sized to receive and support a planter base with a diameter of twelve inches in a retracted position.

10. The expandable plant caddy of claim 1, wherein the expandable plant caddy is sized to receive and support a planter base with a diameter of sixteen inches in an expanded position.

11. The expandable plant caddy of claim 1, wherein the plurality of plates further comprises at least three plates.

12. The expandable plant caddy of claim 1 further comprising a plurality of casters, each mounted to one of the plurality of plates for transportation of the expandable plant caddy upon the underlying support surface.

13. The expandable plant caddy of claim 12 wherein each of the plurality of casters are mounted to the corresponding plate of the plurality of plates with the corresponding leg of the plurality of legs therebetween to apply compression upon the corresponding leg to resist inadvertent adjustment of each of the plurality of plates.

14. The expandable plant caddy of claim 13, further comprising a plurality of guides, each mounted to one of the plurality of plates to connect each plate for translation along one of the plurality of legs; and
wherein the corresponding caster of the plurality of casters is mounted to the corresponding guide of the plurality of guides.

15. The expandable plant caddy of claim 14 further comprising a plurality of fasteners connecting the plurality of casters to the plurality of guides.

16. The expandable plant caddy of claim 15 wherein each of the plurality of fasteners is installed under tension.

17. An expandable plant caddy comprising:
a frame with a plurality of legs;
a plurality of plates each mounted for translation to one of the plurality of legs, to collectively support a planter, and to expand and retract to adjust an overall size of the plurality of plates; and
a plurality of casters each mounted to one of the plurality of plates with the corresponding leg therebetween to apply compression upon the corresponding leg to resist inadvertent adjustment of each of the plurality of plates, and to permit travel of the expandable plant caddy upon an underlying support surface.

18. The expandable plant caddy of claim 17, wherein the plurality of casters further comprises at least three casters.

19. The expandable plant caddy of claim 18, further comprising a plurality of fasteners connecting the plurality of casters to the plurality of plates.

20. An expandable plant caddy assembly comprising:
a frame with a plurality of legs;
a plurality of plates each mounted for translation to one of the plurality of legs, to collectively support a planter, and to allow expansion to accommodate planters of varying sizes;
a plurality of guides, each mounted to one of the plurality of plates to connect each plate for translation along the corresponding leg of the plurality of legs; and
a plurality of casters each mounted to one of the plurality of guides with the corresponding leg therebetween to apply compression upon the corresponding leg between the caster and the guide to resist inadvertent adjustment of each of the plurality of plates, and to permit travel of the expandable plant caddy.
